(19) United States
(12) Patent Application Publication
(10) Pub. No.: US 2004/0257522 A1
(43) Pub. Date: Dec. 23, 2004

(54) Method of bonding substrates and apparatus for bonding substrates

(75) Inventors: Hirokazu Masuda, Yokohama-shi (JP); Takashi Takahashi, Yokohama-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Shibura Mechatronics Corporation, Yokohama-shi (JP)

(21) Appl. No.: 10/890,583

(22) Filed: Jul. 14, 2004

Related U.S. Application Data
(63) Continuation of application No. PCT/JP03/15337, filed on Dec. 1, 2002.

(30) Foreign Application Priority Data
Dec. 4, 2002 (JP) 2002-353049

(51) Int. Cl. G02F 1/1339; G02F 1/1341; B32B 31/00; B32B 31/20

(52) U.S. Cl. 349/190; 349/189; 156/145; 156/556

(57) ABSTRACT

A lower holding table and an upper holding table, which hold substrates, respectively, are moved relative to each other, causing one of the substrates to contact the drops of liquid crystal, formed on the other substrate. The substrate that is held on the lower holding table is thereby made to float. Next, the floating substrate is made to abut on the lower holding table. A contact load smaller than the bonding load to be applied to bond the substrates together is thereby applied to the two substrates, thus aligning the substrates with each other in the horizontal direction. The bonding load is applied to the two substrates thus aligned. The substrates are thereby bonded with a seal layer.

### CROSS-REFERENCE TO RELATED APPLICATIONS

This is a Continuation Application of PCT Application No. PCT/JP03/15337, filed Dec. 1, 2003, which was not published under PCT Article 21(2) in English.

This application is based upon and claims the benefit of priority from prior Japanese Patent Application No. 2002-353049, filed Dec. 4, 2002, the entire contents of which are incorporated herein by reference.

### BACKGROUND OF THE INVENTION

1. Field of the Invention

The present invention relates to a method and apparatus for bonding two substrates by using sealing agent, with fluid interposed between the substrates.

2. Description of the Related Art

In the manufacture of flat display panels, a representative example of which is a liquid crystal display panel, two substrates are spaced apart by a predetermined distance, opposing to each other. The gap between the substrates is filled with liquid crystal, which is a fluid, and the substrates are bonded with a sealing agent.

To bond the two substrates together, the sealing agent is applied, forming a frame-shaped layer on the edge parts of one of the substrate. Then, the liquid crystal is dripped in a predetermined amount onto the substrate, forming drops in that region of the substrate, which is surrounded by the frame-shaped layer of the sealing agent. Alternatively, the liquid crystal is dripped in the predetermined amount onto the other substrate, forming drops in that region which opposes the region of the first-mentioned substrate.

Next, the two substrates are held on an upper table and a lower table, respectively. They are spaced apart by the predetermined distance and positioned to oppose each other. In this state, the substrates are aligned in the X, Y and θ directions horizontal planes. The two substrates are then bonded together.

It is demanded that the two substrates be aligned in the horizontal direction with a precision in the order of microns. A high-power camera with a relatively small focal depth is therefore employed to align the substrates.

If the two substrates are spaced apart in the vertical direction by a comparatively a long distance, they cannot be positioned within the focal depth of the high-power camera. In consequence, they cannot be aligned with a high precision. In other words, the precision of aligning the substrates cannot be so high as is desired.

In order to align the two substrates with high precision, the substrates are positioned so close to each other as when they are bonded together, and then are photographed by means of the high-power camera. On the basis of the photograph of the substrates, one of the substrates is moved in the X, Y and θ directions and thus aligned with the other substrate.

If the two substrates are positioned too close, they may contact the sealing agent. Once they contact the sealing agent, the force for moving one of the substrates in the horizontal direction in accordance with the photograph increases due to the viscosity resistance of the sealing agent. Therefore, the substrate cannot be moved precisely or smoothly.

If the two substrates are positioned too close, not only the sealing agent bonds the substrates together, but also the drops of liquid crystals on one of the substrates collapse and fill the gap between the substrates. Consequently, the liquid crystal increases the adhesive bonding of the substrates. This renders it difficult to move one substrate horizontally with respect to the other, exactly by a desired distance. Ultimately, it is impossible to align the substrates smoothly or precisely.

An object of the present invention is to provide a method and apparatus for bonding two substrates, by moving one of the substrates with a relatively small force thereby to align the substrates with high precision and to enhance the quality of the twos substrates bonded together.

### BRIEF SUMMARY OF THE INVENTION

The present invention provides a method of bonding substrates. In the method, a frame-shaped seal layer is provided on one of two substrates. Then, a fluid is dripped, forming drops in that region of one of the two substrates which lies within the frame-shaped seal layer. A bonding load is applied to the two substrates, thereby to bond the substrates together.

The method is characterized by comprising:

a step of holding one of the substrates on a lower holding table;

a step of holding the other substrate on an upper holding table which opposes the lower holding table;

a step of driving at least one of the holding tables, moving the lower and upper holding table toward each other;

a step of causing the one of the substrates to float from the lower holding table, by causing the two substrates to contact the fluid and by using a surface tension of the fluid, which attracts the two substrates to each other;

a step of causing the one of the substrates, which is floating, to abut on the lower holding table and applying a contact load which is smaller than the bonding load;

a step of moving at least one of the holding tables in a horizontal direction, thereby aligning the two substrates with each other, while the contact load is being applied to the two substrates; and

a step of applying the bonding load to the two substrates aligned with each other, and bonding the substrates together by using the seal layer.

The present invention provides an apparatus for bonding substrates, too. In the apparatus, a frame-shaped seal layer is provided on one of two substrates, drops of a fluid are formed by dripping the fluid, in that region of one of the two substrates which lies within the frame-shaped seal layer, and a bonding load is applied to the two substrates, thereby to bond the substrates together.

The apparatus is characterized by comprising:

a lower holding table which holds one of the substrates;

an upper holding table which opposes the lower holding table and which holds the other substrate;

drive means for driving the upper holding table toward and away from the lower holding table;

aligning means for aligning the two substrates moved relative to each other by the drive means in a horizontal direction while the two substrates are contacting the fluid by virtue of a contact load smaller than the bonding load; and

control means which controls the drive means to make the upper holding table stop moving down when the two substrates contact each other due to the contact load, and controls the drive means to apply the bonding load to the substrates when the aligning means aligns the substrates with each other,

wherein the lower holding table holds the one of the substrates with a force smaller than a force which is generated from a surface tension of the fluid when the two substrates contact the fluid, which attracts the two substrates to each other and which makes the one of the substrate float from the lower holding table.

### BRIEF DESCRIPTION OF THE SEVERAL VIEWS OF THE DRAWING

FIG. 1 is a schematic representation of a system designed to assemble a liquid crystal display panel according to an embodiment of the present invention;

FIG. 2 is a sectional view schematically illustrating the substrate-bonding apparatus incorporated in the system and designed to bond a pair of substrate together; and

FIGS. 3A to 3E are sectional views that explain a sequence of bonding a pair of substrates.

### DETAILED DESCRIPTION OF THE INVENTION

An embodiment of the present invention will be described, with reference to the accompanying drawings.

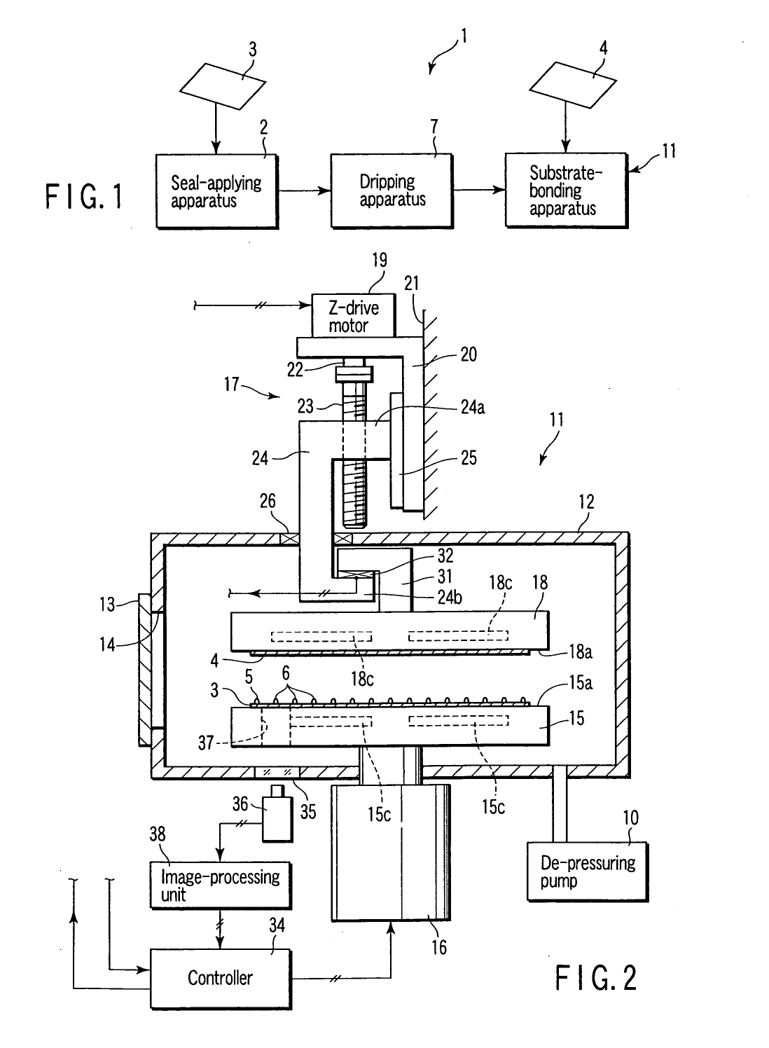

FIG. 1 is a schematic representation of a system 1 that is designed to assemble a liquid crystal display panel according to an embodiment of the invention. The system 1 has a seal-applying apparatus 2 for applying a sealing agent. A first substrate 3 is supplied to the seal-applying apparatus 2. The first substrate 3 is to be bonded to a second substrate 4.

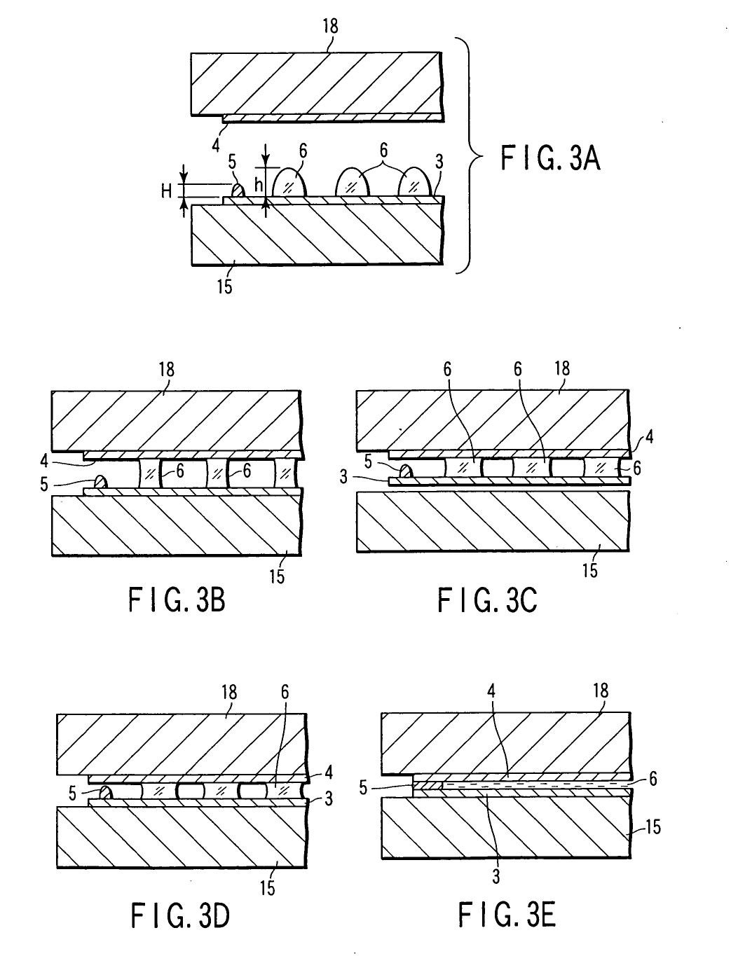

The seal-applying apparatus 2 has a table (not shown) and a seal-applying nozzle (not shown) located above the table. The table holds the first substrate 3. The seal-applying nozzle is driven relative to the first substrate 3, in the X, Y and θ directions, applying a sealing agent 5 that is viscous elastic material. That is, the sealing agent 5 is applied to the inner side of the first substrate 3 (i.e., the surface at which the substrate 3 is to be bonded to another substrate), along the edges of the first substrate 3. The sealing agent 5 thus applied forms a frame-shaped layer (shown in FIG. 3).

The first substrate 3 applied with the sealing agent 5 is supplied to a dripping apparatus 7. The dripping apparatus 7 has a table (not shown) and a dripping nozzle (not shown) located above the table. The table holds the first substrate 3. The dripping nozzle is driven relative to the first substrate 3, in the X, Y and θ directions. While so driven, the dripping nozzle drips liquid crystal which is a fluid onto the first substrate 3, forming drops 6 of liquid crystal in that region of the first substrate 3 which is surrounded by the frame-shaped layer of sealing agent. The drops 6 are arranged in a prescribed pattern, for example in rows and columns.

The drops 6 of liquid crystal, formed on the first substrate 3, have height h that is greater than the height H of the seal layer 5 as shown in FIG. 3A. If the liquid crystal is applied to the first substrate 3 in a fixed amount, the volume of each drop 6 and, hence, the height h thereof are determined by the number of drops 6 formed on the first substrate 3. Hence, the height h can be greater than H, namely h >H, by adjusting the number of drops 6 to be formed, on the basis of the fixed amount in which the liquid crystal is applied.

The first substrate 3 now having the drops 6 of liquid crystal is supplied to a substrate-bonding apparatus 11. The other substrate, or the second substrate 4, is supplied to the substrate-bonding apparatus 11. In the apparatus 11, the first substrate 3 and the second apparatus 4 are aligned to each other and bonded together, as will be described later. As the substrates 3 and 4, which make a pair, are bonded together by using the seal layer 5, the liquid crystal 6 is sealed in the gap between these substrates 3 and 4.

As FIG. 2 depicts, the substrate-bonding apparatus 11 has a chamber 12. The chamber 12 is de-pressured to, for example, 1 Pa, when the de-pressuring pump 10 is driven. The chamber 12 has a port 14 in one side. The port 14 can be closed with a shutter 13. Through the port 14, the first substrate 3 and the second substrate 4 can be inserted into, and taken from, the chamber 12.

The chamber 12 contains a lower holding table 15. The lower holding table 15 can be driven in the X, Y and θ directions by a XYθ driver 16. The first substrate 3 is placed on the holding surface 15a (upper surface) of the lower holding table 15 and positioned with its inner surface turned upwards. The inner surface of the first substrate 3 is applied with the sealing agent 5 and the drops 6 of liquid crystal on its upper. The substrate 3 has its outer surface (e.g., lower surface) held on the holding surface 15a, by virtue of a predetermined holding force that is, for example, an electrostatic force.

An upper holding table 18 is provided above the lower holding table 15. The table 18 can be driven by a drive unit 17 in the Z direction, toward and away from the lower holding table 15. The second substrate 4 is held on the lower surface of the upper holding table 18, or holding surface 18a, by virtue of an electrostatic force. The second substrate 4 is so held, with its outer surface contacting the upper holding table 18.

A plurality of electrodes 15c and a plurality of electrodes 18c are provided on the holding tables 15 and 18, respectively. These electrodes 15c and 18c generate electrostatic forces when a power supply (not shown) supplies electric power to them. The electrostatic forces hold the substrates 3 and 4 on the holding tables 15 and 18, respectively.

The drive unit 17 has a Z-drive motor 19. A bracket 20 secures the Z-drive motor 19 to a holding section 21. The motor 19 has a shaft 22, to which a screw shaft 23 is coupled. The screw shaft 23 is set in screw engagement with the upper part 24a of a movable member 24 that is shaped like letter C. The distal end of the upper part 24a is held in sliding contact with a linear guide 25 that is provided on the bracket 20 and extends in the vertical direction. Thus, the movable member 24 can move up and down along the linear guide 25 when the Z-drive motor 19 rotates the screw shaft 23 that is coupled to the shaft 22 of the motor 19.

The movable member 24 extends into the chamber 12 and can move up and down. It is held in airtight fashion by means of a sealing mechanism 26 that is provided in the top wall of the chamber 12. The lower part 24b of the C-shaped movable member 24 holds the horizontal part of an L-shaped stopper 31 that is secured to the upper surface of the upper holding table 18. A load cell 32 is interposed between the movable member 24 and the stopper 31. The load cell 32 is designed to detect the load applied on the movable member 24 of the drive unit 17.

The XYθ driver 16 and the Z-drive motor 19 are driven by drive signals supplied from a controller 34. The load cell 32 generates a signal representing the load applied on the movable member 24. The signal is input to the controller 34.

The chamber 12 has a window 35 made in the bottom wall. The window 35 is optically transparent. A high-power photographing camera 36 is located, opposing the window 35. When the first and second substrates 3 and 4 are positioned close to each other as will be described later, the photographing camera 36 photographs the alignment marks (not shown) provided on the four corners of the first substrate 3 held on the lower holding table 15. The camera 36 also photographs the alignment marks (not shown) provided on the four corners of the second substrate 4 held on the upper holding table 18. Note that the alignment marks on the corners of either substrate are seen through the opening 37 made in the lower holding table 15.

Another camera (not shown) is arranged near the high-power photographing camera 36. This camera that has a smaller magnifying power than the high-power photographing camera 36 is used to achieve coarse alignment of the first and second substrates 3 and 4.

The photographing camera 36 generates a video signal, which is supplied to an image-processing unit 38. The unit 38 converts the video signal to a digital signal. The digital signal is input to the controller 34. From the digital signal, the controller 34 calculates the relative displacement between the first substrate 3 and the second substrate 4, i.e., the horizontal displacement between the first substrate 3 and the second substrate 4.

The controller 34 generates a signal representing the displacement and supplies this signal to the XYθ driver 16. Driven by this signal, the XYθ driver 16 drives the lower holding table 15. The first substrate 3 held on the table 15 is thereby moved into alignment with the second substrate 4.

The sequence that the substrate-bonding apparatus 11 performs to bond the first substrate 3 and the second substrate 4 will be described, with reference to FIGS. 3A to 3E.

As FIG. 3A shows, the first substrate 3 and second substrate 4 are placed on the lower holding table 15 and upper holding table 18, respectively. Thus, the substrates 3 and 4 oppose each other, vertically spaced apart by a predetermined distance. The camera (not shown) for achieving the coarse alignment photographs the four corners of either substrate. Then, the substrates 3 and 4 are coarsely aligned in the X, Y and θ directions in accordance with the photographed images of the four corners of either substrate.

Next, the drive unit 17 drives the upper holding table 18 downwards at a low speed. When the second substrate 4 approaches the first substrate 3 as shown in FIG. 3B, the lower surface of the second substrate 4 contacts the drops 6 of liquid crystal that are formed on the upper surface of the first substrate 3 and have height h greater than the height H of the seal layer 5. The drops 6 are deformed due to capillary action. More precisely, the drops 6, which are semispherical as shown in FIG. 3A, change to drops shaped like a hourglass as illustrated in FIG. 3B.

The drops 6 of liquid crystal tend to restore the semispherical shape by virtue of surface tension. The surface tension attracts the first substrate 3 toward the second substrate 4. At this time, the first substrate 3 temporarily float from the lower holding table 15 as shown in FIG. 3C if the surface tension is greater than the sum of the force holding the first substrate 3 on the table 15 and the weight of the first substrate 3.

As the drive unit 17 further drives the upper holding table 18 downwards at the low speed, the first substrate 3 contacts the upper surface of the lower holding table 15 as shown in FIG. 3D, and the drops 6 of liquid crystal receive the weight of the upper holding table 18 holding the second substrate 4. This decreases the load applied from the upper holding table 18 via the stopper 31 to the movable member 24.

Since the load applied to the movable member 24 decreases, the load detected by the load cell 32 interposed between the movable member 24 and the stopper 31 decreases, too. The signal generated by the load cell 32 therefore changes in magnitude. This changes in the signal makes the controller 34 stop the Z-drive motor 19. As a result, the upper holding table 18 stops moving downwards.

When the load detected by the load cell 32 changes and, hence, the upper holding table 18 stops moving downwards, the second substrate 4 contacts the drops 6 of liquid crystal, collapsing the drops 6 a little as shown in FIG. 3D. Nonetheless, the liquid crystal does not fill up the gap between the first and second substrates 3 and 4. Moreover, the substrates 3 and 4 are so spaced that the second substrate 4 has yet to contact the seal layer 5. In other words, a load is applied to make the two substrates 3 and 4 contact eventually.

Since the drive unit 17 is stopped when the load detected by the load cell 32 changes, a contact load is applied to the first substrate 3 and the second substrate 4. The contact load is smaller than the bonding load that bonds the substrates 3 and 4, set to about 40 to 50% of the bonding load. Thus, the contact load is 80 to 100 kg if the bonding load is 200 kg.

As described above, the first and second substrates 3 and 4 remain spaced apart such that the liquid crystal 6 does not fill up the gap between these substrates 3 and 4 and that the second substrate 4 does not contact the seal layer 5. That is, the drops 6 of liquid crystal do not join to fill up the gap between a pair of substrates 3 and 4, though they are deformed, from the semispherical ones shown in FIG. 3A to hourglass-shaped ones shown in FIG. 3D.

Hence, the liquid crystal 6 generates no force at the entire surface of one substrate, which opposes the other substrate. Nor will the second substrate 4 contact the seal layer 5. Therefore, it is possible to move the first substrate 3 smoothly and precisely to align it with the second substrate 4.

As shown in FIG. 3C, the second substrate 4 contacts the drops 6 of liquid crystal and the first substrate 3 floats from the lower holding table 15. This brings forth an advantage. The first substrate 3 floats to a level where the force attracting the first substrate 3, resulting from surface tension, is balanced with the weight of the first substrate 3. Then, the upper holding table 18 is further moved downwards, while the first and second substrates 3 and 4 are still spaced from each other. The first substrate 3 soon contacts the lower holding table 15, applying a load to the lower holding table 15. At the time a contact load is applied to the table 15, the upper holding table 18 stops moving down.

When the upper holding table 18 stops moving downwards, the first and second substrates 3 and 4 are spaced by a distance determined by the surface tension of the liquid crystal 6. The gap between the two substrates 3 and 4 will not further decrease due to the surface tension of the liquid crystal 6 when the first substrate 3 contacts the lower holding table 15 and applies a contact load to the lower holding table 15. The contact load does not decrease. Nor is the first substrate 3 prevented from floating. Hence, a sufficient contact load can be reliably exerted on both substrates 3 and 4.

By virtue of this contact load, the liquid crystal 6 does not fill up the gap between the substrates 3 and 4. Thus, no force is generated over the entire surface of each substrate, which opposes the other substrate. This renders it possible for the lower holding table 15 to move smoothly and precisely to align the first substrate 3 with the first substrate 4.

While a contact load is being applied to both substrates 3 and 4, the photographing camera 36 photographs the alignment marks (not shown) provided on the four corners of the first substrate 3 and also the alignment marks (not shown) provided on the four corners of the second substrate 4. The camera 36 generates video signals, which are supplied to the image-processing unit 38. The unit 38 converts the video signals to digital signals, which are input to the controller 34. According to the digital signals, the controller 34 controls the XYθ driver 16, which drives the lower holding table 15. The first substrate 3 held on the table 15 is thereby moved and aligned with the second substrate 4 with high precision.

The contact loads applied to the first and second substrates 3 and 4 to align the first substrate 3 with the second substrate 4 are maintained at the contact load determined from the signal generated by the load cell 32. Therefore, the second substrate 4 remains spaced from the seal layer 5 applied to the first substrate 3, and the gap between the first and second substrates 4 and 5 remains not filled up with the liquid crystal 6.

The adhesive force of the seal layer 5 does not acts on the second substrate 4, nor adhesive force of the liquid crystal 6 is generated over the entire surface of each substrate, which opposes the other substrate, even the above-mentioned contact loads move both substrates 3 and 4 within the focal depth of the photographing camera 36. Hence, the first substrate 3 can be moved, with a relatively small force, in the X, Y and θ directions with respect to the second substrate 4. The substrates 3 and 4 can, therefore, be aligned with high precision.

Assume that the drops 6 of liquid crystal contact one another, filling up the gap between a pair of substrates 3 and 4. Then, the adhesive force of the liquid crystal 6 will acts on the entire opposing surfaces of the substrates 3 and 4. If this happens, the force firmly bonding the substrates 3 and 4 will increase, making it no longer possible to move the first substrate 3 horizontally by a desired distance with respect to the second substrate 4.

Nonetheless, the forces applied to the substrates 3 and 4 to align them with each other are contact loads. Hence, the drops 6 of liquid crystal do not contact one another, not filling up the gap between the substrates 3 and 4. Nor does the second substrate 4 contact the seal layer 5. The first substrate 3 can therefore be moved smoothly, though receiving a small resistance. This helps to enhance the precision of aligning the substrates 3 and 4 with each other.

After the first substrate 3 and the second substrate 4 are thus aligned, the Z-drive motor 19 further moves the upper holding table 18 downwards, exerting a bonding force to bond the substrates 3 and 4 together. As a result, the gap between the substrates 3 and 4 decreases as illustrated in FIG. 3E, from the distance by which the substrates 3 and 4 were spaced apart when they were aligned. The seal layer 6 bonds the substrates 3 and 4 to each other. The gap between the substrates 3 and 4 is thereby filled up with the liquid crystal 6.

When the substrates 3 and 4 are thus bonded in the chamber 12, the electrostatic charge is removed from the upper holding table 18. The upper holding table 18 is moved upwards, and a gas is introduced into the chamber 12. Then, the substrates 3 and 4 are bonded more firmly, because the pressure in the chamber 12 is now higher than the pressure in the gap between the substrates 3 and 4. This ensures a reliable bonding of the substrates 3 and 4.

The substrate-bonding apparatus according to the embodiment described above can align the first substrate 3 with the second substrate 4 with high precision, as has been explained with reference to FIGS. 3C and 3D. The first and second substrates 3 and 4 can therefore be bonded together with high precision. This serves to enhance the quality of liquid crystal display panels, which are manufactured by bonding two substrates 3 and 4.

Since the contact load can be reliably applied to the two substrates 3 and 4, they need not undergo feedback control while the lower holding table 15 is moving the first substrate 3 to align it with the second substrate 4. This can simplify the control performed by the drive unit 17.

The present invention is not limited to the embodiment described above. The invention can be applied to a method of bonding a pair of substrates 3 and 4 in the atmosphere. In the embodiment, the sealing agent 5 is applied to the first substrate 3, and the liquid crystal 6 is dripped onto the first substrate 3. Instead, the sealing agent may be applied to one of the two substrates, and the liquid crystal may be applied to the other substrate.

As indicated above, the second substrate 4 contacts the drops 6 of liquid crystal but does not contact the seal layer 5, in the process of aligning the pair of substrates 3 and 4. Nonetheless, the substrates 3 and 4 can be aligned with each other even if the second substrate 4 contacts the seal layer 5, if the sealing agent 5 has a small viscosity and, hence, exerts a low viscosity resistance.

As specified above, the first substrate 3 is held on the lower holding table 15 by virtue of an electrostatic force. Instead, an elastic sheet made of, for example, rubber may be adhered to the upper surface of the lower holding table 15. In this case, the friction between the elastic sheet and the first substrate 3 prevents the first substrate 3 from moving on the holding surface 15a of the lower holding table 15. The elastic sheet may be as large as the lower holding table 15. The elastic sheet may be divided into a plurality of pieces.

An elastic sheet is provided on the upper surface of the lower holding table 15 and the first substrate 3 is held without employing electrostatic attraction or vacuum attraction or using a mechanical attracting means. If this is the case, the first substrate 3 will easily float from the lower holding substrate 15 when the second substrate 4 contacts the drops 6 of liquid crystal as the upper holding table 18 moves down. This is because the surface tension of the liquid crystal 6, which now contacts the liquid crystal drops 6, attracts the first substrate 3.

Hence, the surface tension of the liquid crystal 6, i.e., the force that tends to narrow the gap between the two substrates 3 and 4, can be reduced more reliably than in the case where an electrostatic force attracts the first substrate 3 to the lower holding table 15. Even if the upper holding table 18 stops moving down due to a contact load, the gap between the two substrates 3 and 4 will not decrease in spite of the surface tension of the liquid crystal 6. Since the gap between the substrates 3 and 4 does not decrease, the contact load does not decrease, and the first substrate 3 is prevented from floating.

Therefore, the contact load can reliably be applied to the two substrates 3 and 4. As a result, the substrates 3 and 4 remain so spaced the liquid crystal 6 will not fill up the gap between the substrates 3 and 4 and any adhesive force will not be generated over the entire surface of each substrate, which opposes the other substrate.

Thus, to align the two substrates 3 and 4 that are positioned close to each other, the lower holding table 15 can be moved more smoothly and precisely if an elastic sheet is adhered to the lower holding table 15 than if the first substrate 3 is attracted to the lower holding table 15 by virtue of an electrostatic force as in the above-described embodiment.

In the process of aligning the two substrates 3 and 4 with each other, the friction between the first substrate 3 and the elastic sheet and the force (contact load) pressing the first substrate 3 to the elastic sheet prevents the first substrate 3 from moving in the direction the lower holding table 15 is moved. The substrates can therefore be aligned well, without the necessity of using a substrate-holding means that applies an electrostatic attraction or a vacuum attraction or a mechanical unit that holds the first substrate 3. This helps to simplify the substrate-bonding apparatus and enhance the operability of the apparatus, and makes it easy to maintain the apparatus in good conditions.

The elastic sheet must be a member that exerts between it and the substrate 3 a frictional force that is greater than the resistance that acts between the substrates 3 and 4 while the substrates 3 and 4 are being aligned with each other.

It is desired that one surface-region (defining the holding surface) of the elastic sheet be made of non-adhesive material or be surface-treated so that the first substrate 3 and the elastic sheet may be easily separated from each other.

A holding mechanism that exerts an electrostatic attraction or a vacuum attraction may be used, as well as the elastic sheet. In this case, the holding mechanism may be one that generates a smaller attraction than the holding mechanism, such as an electrostatic chuck, provided on the upper holding table 18. Alternatively, it may be another type that does not work while the upper holding table 18 is moving down until it stops due to the contact. Thus, the same advantage as set forth above can be accomplished.

In this invention, the sealing agent can be applied to the second substrate 4 or to both substrates 3 and 4. Further, the liquid crystal 6 may be dripped onto the second substrate 4 or both substrates 3 and 4.

The drive unit 17 is provided on the upper holding table 18. Instead, the unit 17 may be provided on the lower holding table 15. Moreover, two drive units may be provided on the holding tables 17 and 18, respectively.

The load cell 32, which is used as load-detecting means, is provided on the drive unit 17. Instead, the load cell 32 may be provided, for example, between the lower holding table 15 and the XYθ driver 16. It suffices if the load cell 32 is so located to detect the loads applied on the two substrates 3 and 4 that are to be bonded together.

As has been described, the present invention can reduce the resistance that the liquid crystal generates between two substrates when the substrates approach each other to be bonded together. Hence, the substrates can be aligned smoothly and precisely. The product comprising the two substrates thus bonded can therefore have high quality.

What is claimed is:

1. A method of bonding substrates, in which a frame-shaped seal layer is provide on one of two substrates, drops of a fluid are formed by dripping the fluid, in that region of the one of the two substrates which lies within the frame-shaped seal layer, and a bonding load is applied to the two substrates, thereby to bond the substrates together, the method comprising:
a step of holding one of the substrates on a lower holding table;
a step of holding the other substrate on an upper holding table which opposes the lower holding table;
a step of driving at least one of the holding tables, moving the lower and upper holding table toward each other;
a step of causing the one of the substrates to float from the lower holding table, by causing the two substrates to contact the fluid and by using a surface tension of the fluid, which attracts the two substrates to each other;
a step of causing the one of the substrates, which is floating, to abut on the lower holding table and applying a contact load which is smaller than the bonding load;
a step of moving at least one of the holding tables in a horizontal direction, thereby aligning the two substrates with each other, while the contact load is being applied to the two substrates; and
a step of applying the bonding load to the two substrates aligned with each other, and bonding the substrates together by using the seal layer.

2. The method of bonding substrates, according to claim 1, wherein the drops of fluid formed on the substrate have a height greater than a height of the seal layer.

3. The method of bonding substrates, according to claim 1, wherein the contact load is one which does not collapse the drops of fluid to fill up a gap between the two substrates moved close to each other and which prevents the two substrates from being bonded with the seal layer, so that the two substrates remain spaced from each other.

4. An apparatus for bonding substrates, in which a frame-shaped seal layer is provided on one of two substrates, drops of a fluid are formed by dripping the fluid, in that region of one of the two substrates which lies within the frame-shaped seal layer, and a bonding load is applied to the two substrates, thereby to bond the substrates together, the apparatus comprising:
a lower holding table which holds one of the substrates;
an upper holding table which opposes the lower holding table and which holds the other substrate;
drive means for driving the upper holding table toward and away from the lower holding table;
aligning means for aligning the two substrates moved relative to each other by the drive means in a horizontal direction while the two substrates are contacting the fluid by virtue of a contact load smaller than the bonding load; and
control means which controls the drive means to make the upper holding table stop moving down when the two substrates contact each other due to the contact load, and controls the drive means to apply the bonding load to the substrates when the aligning means aligns the substrates with each other,
wherein the lower holding table holds the one of the substrates with a force smaller than a force which is generated from a surface tension of the fluid when the two substrates contact the fluid, which attracts the two substrates to each other and which makes the one of the substrate float from the lower holding table.
